(19) United States
(12) Patent Application Publication
(10) Pub. No.: US 2016/0263929 A1
(43) Pub. Date: Sep. 15, 2016

(54) Plasma Treatment of Flexographic Printing Surface

(71) Applicant: 3M INNOVATIVE PROPERTIES COMPANY, Saint Paul, MN (US)

(72) Inventors: Shawn C. Dodds, St. Paul, MN (US); John P. Baetzold, North St. Paul, MN (US); Moses M. David, Woodbury, MN (US); Mikhail L. Pekurovsky, Bloomington, MN (US); Kim B. Saulsbury, Lake Elmo, MN (US); Matthew S. Stay, Minneapolis, MN (US)

(21) Appl. No.: 15/028,688

(22) PCT Filed: Oct. 3, 2014
(86) PCT No.: PCT/US14/59145

§ 371 Date: Apr. 11, 2016

Related U.S. Application Data
(60) Provisional application No. 61/889,580, filed on Oct. 11, 2013.

(51) Int. Cl. B41N 1/06; B41M 1/04; B41C 1/00

(52) U.S. Cl. CPC B41N 1/06; B41C 1/006; B41M 1/04

(57) ABSTRACT

A method of plasma treating a flexographic printing plate and a method of using a plasma-treated flexographic printing plate to transfer a liquid to a printable substrate are disclosed. A method of flexographic printing comprises: transferring the liquid from an anilox roll to a printing surface of the plasma-treated flexographic printing plate and transferring the liquid from the printing surface of the plasma-treated flexographic printing plate to a surface of the substrate. A method of plasma treating the flexographic printing plate comprises exposing at least the printing surface of the flexographic printing plate to a plasma.

### BACKGROUND

Flexographic printing has been widely used for many diverse printing applications. In flexographic printing a liquid is transferred from a printing surface of a flexographic printing plate, to a substrate to be printed. Substrates to be printed have been subjected to processes such as plasma treatment to enhance the printability of the substrate by e.g. increasing the surface energy of the substrate, as discussed by Wolf (“Game-Changing Surface-Pre-Treatment Technology”; Converting Quarterly, October 2011). Correspondingly, it has historically been thought that the printing surface of a flexographic printing plate should have a surface energy that is lower than that of the substrate to be printed, in order to promote transfer of the liquid from the printing surface of the flexographic printing plate onto the substrate (or it has been thought that, at most, the surface energy of the printing plate will have little or no influence on the liquid transfer and thus on the print quality), as discussed by Liu and Guthrie (“A Review of Flexographic Printing Plate Development”; Surface Coatings International Part B: Coating Transactions, June 2003, 86, B2).

### SUMMARY

In broad summary, herein is disclosed a method of plasma treating a flexographic printing plate, and a method of using such a plasma-treated flexographic printing plate to transfer a liquid to a printable substrate. These and other aspects of the invention will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a side schematic cross sectional view of an exemplary flexographic printing apparatus.

FIG. 2 is a side schematic cross sectional view of an exemplary flexographic printing plate.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated. Although terms such as “top”, bottom”, “upper”, lower”, “under”, “over”, “front”, “back”, “outward”, “inward”, “up” and “down”, and “first” and “second” may be used in this disclosure, it should be understood that those terms are used in their relative sense only unless otherwise noted. As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match. The term “plate”, as used in e.g. a flexographic printing plate, is used herein for convenience; however, the use of the term plate does not require that any such plate must necessarily be, or must have ever been in, a flat (planar) format.

### DETAILED DESCRIPTION

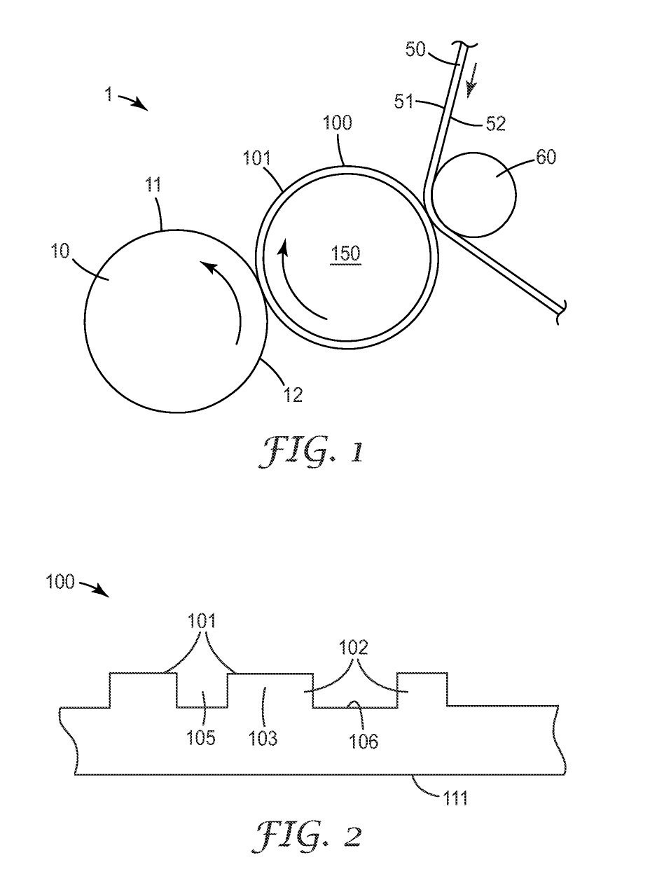

Shown in FIG. 1 in side schematic cross sectional view is an exemplary flexographic printing apparatus 1. Apparatus 1 comprises flexographic printing plate 100 which may be mounted e.g. onto the exterior surface of a printing cylinder 150 (or which, in some embodiments, may itself be supplied in cylindrical form). An anilox roll 10 may be provided which may receive a liquid into cells 12 (not visible in detail in FIG. 1) of exterior surface 11 of anilox roll 10. Movement (e.g., rotation) of anilox roll 10 and printing cylinder 150 causes the liquid to be transferred (in a metered amount) from cells 12 of anilox roll 10, onto printing surfaces 101 (not visible in detail in FIG. 1) of flexographic printing plate 100. Continued movement (e.g., rotation) of printing cylinder 150 causes the liquid to be transferred from printing surfaces 101 of flexographic printing plate 100, onto first major surface 51 of printable substrate 50. Often, a backing (impression) roll 60 is provided which supports second surface 52 of printable substrate 50.

In some embodiments, flexographic printing plate 100 may be processed as a flat plate (e.g., as shown in FIG. 2) to impart it with a desired printing pattern, and then curved and fitted onto the exterior surface of printing cylinder 150 if desired. An adhesive (or any suitable means of bonding or attachment) may be provided on the backside 111 of flexographic printing plate 100, in order to facilitate the mounting of plate 100 onto printing cylinder 150. As mentioned, in some embodiments flexographic printing plate 100 may be provided in cylindrical form rather than as a flat plate that may be eventually wrapped around a printing cylinder. It will be appreciated that other ancillary components (e.g., one or more of liquid reservoirs, metering rolls, fountain rolls, doctor blades, idler rolls, substrate guides, safety shrouds, and so on) are often used with such a flexographic printing apparatus, but are not shown in FIG. 1 for convenience of presentation.

Exemplary flexographic printing plate 100 is shown (in this particular illustration, plate 100 is in a generally flat form, e.g. prior to being wrapped around a printing cylinder) in further detail in FIG. 2. Plate 100 comprises printing surface 101 (the term printing surface being used to collectively indicate all of the individual surfaces which the liquid is transferred to and from) which is present atop relief (raised) protrusions 102. This arrangement of raised protrusions 102 interspersed with (e.g., separated by) valleys 105 can be achieved by any well-known method of preparing flexographic printing plates. At least an upper portion (as the plate is viewed in FIG. 2) of plate 100 is comprised of flexographic plate material 103. In some general types of embodiments, plate material 103 may be derived from a flexographic plate precursor material, at least portions of which precursor material are removable. In a first embodiment of this general type, such portions are removable by mechanical ablation and/or energetic means such as e.g. laser engraving, which can remove selected portions of the precursor material to form valleys 105 while leaving behind raised protrusions 102. In such embodiments the precursor material may be provided (for the removal process) substantially in the form in which it is eventually used in the printing process. In a second embodiment of this general type, a precursor material is provided in a form in which it is removable e.g. by washing with a solvent (with the word solvent encompassing any liquid or liquid mixture that can remove such a material), unless the precursor material has been treated so as to be stabilized and strengthened. In a well-known version of this, the precursor material may be a photocurable material, desired portions of which can be photopolymerized and/or cross-linked (e.g. via an imaging process), after which the precursor material is contacted with a solvent that removes non-photocured portions of the material to form valleys 105, thus leaving behind raised protrusions 102. Many different variations of these arrangements and processes are known, of course.

In other general types of embodiments, flexographic printing plate 100 may be provided by molding a flexographic plate precursor material against a master mold whose surface contains a relief pattern that is complementary to the relief pattern that is desired to be provided in plate material 103. The molding process will thus produce a flexographic plate material 103 with the desired relief structure. Such a plate precursor material may be any suitable flowable (moldable) material, whether thermoplastic, thermoset, and so on, as will be well understood by the ordinary artisan. In a variation of such approaches, an embossable plate precursor material may be used, which, while it may not necessarily approach such low viscosity as e.g. a moldable material, nevertheless will soften sufficiently upon being heated to allow the desired relief pattern to be formed therein, which pattern is maintained upon cooling of the embossable plate precursor material. The ordinary artisan will appreciate that there may not necessarily be a strict dividing line between a moldable plate material and an embossable plate precursor material; all such variations of this general approach are encompassed by the disclosures herein.

It is emphasized that flexographic printing plate 100 may be directly provided in cylindrical form rather than as a flat plate that may then be wrapped around a support cylinder. For example, a plate precursor material could be deposited (in any desired manner) onto the surface of a cylinder or mandrel, and then processed e.g. to remove (whether by e.g. laser ablation, mechanical machining, solvent washing, and so on) plate precursor material as desired to leave behind the desired relief pattern. Such a cylindrical plate may then be used without the necessity of mounting it onto a support cylinder.

FIG. 2 shows a simplified representation of a flexographic printing plate, for ease of representation. Often, such a flexographic printing plate may comprise one or more additional layers (that is, it is not necessary that the entire thickness of plate 100, down to lower surface 111, consist of flexographic plate material 103). For example, one or more support layers may be provided in lower portions of the plate. Also, a flexographic printing plate as inputted into a laser engraving or imaging process may have other ancillary components (e.g. a stencil through which electromagnetic energy is imaged onto the precursor material, an ablatable layer which may be ablated by a laser to form a stencil in-situ as is commonly done e.g. in some forms of digital flexographic printing, and so on). Flexographic printing plates are widely available; e.g. from DuPont (Wilmington, Del.) under the trade designation CYREL, from the Flint Group (Arden, N.C.) under the trade designation NYLOFLEX, and from MacDermid Inc. (Denver, Colo.) under various trade designations.

A precursor material of a flexographic plate 100 may be of any suitable composition for use in e.g. a mechanical ablation, laser engraving, or solvent-washing method. In the particular embodiment in which the precursor material is a photocurable material (e.g. for an imaging/solvent-washing method of plate preparation), it may comprise any suitable photopolymerizable or photocrosslinkable monomer, oligomer, polymer, or combination or mixtures thereof. (It may further contain any suitable additives such as photoactivators or photocatalysts, stabilizers, fillers, and so on.) One broad category of suitable materials includes the well known (meth)acrylate family of materials (whether monomers, oligomers, polymers, etc.). Materials of this type (as well as various other reactive materials, additives and ancillary components) that may be suitable for use in a flexographic printing plate precursor material are described e.g. in U.S. Patent Application Publication No. 2010/0077932 to Pekurovsky. If the flexographic plate is to be prepared by e.g. mechanical ablation or laser engraving, the precursor material may not need to be reactive (and in particular may not need to be photocurable). Such a precursor material (which may thus be of similar or same composition to plate material 103, portions of the precursor material merely having been removed to leave behind the plate material) may include e.g. rubber compounds such as natural rubber, butyl rubber, neoprene rubber, and the like.

In general, suitable flexographic plate precursor materials may be chosen from e.g. natural or synthetic rubber, epoxidized natural rubber, chloroprene rubber, nitrile rubber, ethylene-propylene-diene (EPDM) materials, acrylonitrile-butadiene materials, acrylonitrile-butadiene-styrene materials, styrene-butadiene materials. Specific precursor materials that may be suitable for use in flexographic printing plates (as well as ancillary components of such plates) are discussed in detail by Liu and Guthrie (“A Review of Flexographic Printing Plate Development; Surface Coatings International Part B: Coating Transactions, June 2003, 86, B2).

Flexographic printing plate 100 may comprise any suitable printing pattern; that is, it may have any suitable arrangement of raised protrusions 102 collectively bearing printing surface 101 thereupon, interspersed by valleys 105. Individual protrusions 102 may be of any suitable height (meaning the dimension normal to the major plane of the plate, e.g. up and down in the view of FIG. 2) relative to the floor of valleys 105, that is compatible with the desire to transfer a liquid to printing surface 101 and to then transfer the liquid to a printable substrate, while minimizing the degree to which any liquid is transferred onto the floors 106 of valleys 105 and/or is transferred therefrom to a printable substrate). In various embodiments, the height of individual protrusions 102 may be at least about 100, 200, 350, or 500 microns. In further embodiments, the height of individual protrusions 102 may be at most about 2000, 1000, or 600 microns.

The printing surface of an individual protrusion 102 may be of any suitable size and lateral dimension (e.g., length and width). In some embodiments, such a printing surface might be macroscopic in size, e.g. so as to transfer liquid in such dimensions to produce large coated areas to provide items such as e.g. contiguously-printed characters, electrical contact pads, protective coatings, and so on. In some embodiments, such protrusions might be microscopic in size (meaning with at least one lateral dimension that is less than 0.5 mm), so as to transfer liquid in such dimensions as to produce e.g. pixilated images (for any purpose), microscopic electrical traces, and so on. Any such dimension and/or shape may be selected as desired.

As disclosed herein, at least printing surface 101 of flexographic printing plate 100 is a plasma-treated surface. (Often, of course, valley surfaces 106 may also receive at least some plasma treatment unless masked off during the treatment process.) Such plasma treatment may be performed with any suitable apparatus and process. For example, plate 100 (whether e.g. in a flat form prior to being wrapped around a support cylinder, after such a (formerly) flat plate has been wrapped around a support cylinder, or whether plate 100 is in the form of a cylinder itself) may be placed into a chamber of a plasma reactor and a plasma generated in the chamber through any well-known technique.

Any suitable plasma reactor can be used. One suitable type of plasma reactor provides a reaction chamber having a capacitively-coupled system with at least one electrode powered by a radiofrequency (RF) source and at least one grounded electrode. Regardless of the specific type, such a chamber may provide an environment which allows for the control of, among other things, pressure, the flow of various inert and reactive gases, voltage supplied to the powered electrode, strength of the electric field across an ion sheath formed in the chamber, formation of a plasma containing reactive species, intensity of ion bombardment, rate of deposition, and so on. In order to perform the plasma treatment, flexographic printing plate 100 may be placed in, or passed through, the reaction chamber (with at least printing surface 101 thereof exposed to the plasma environment). Plasma, created from a gas or gas mixture within the chamber, may be generated and sustained by supplying power (for example, from an RF generator) to at least one electrode, as will be well understood. Various ancillary components (power sources, oscillators, and so on, are often used in such systems, again as will be well understood). The pressure in the reaction chamber may be maintained at any pressure that is conducive to the formation of a suitable plasma. Often, the plasma reaction chamber may be maintained at a reduced pressure. However, in some embodiments, so called atmospheric pressure plasma treatment may be performed.

In some embodiments, a mode of plasma treatment may be used that involves the positioning of at least the printing surface of the flexographic printing plate within an ion sheath that is established within the reaction chamber of the plasma reactor. Such a mode may provide e.g. enhanced attachment of plasma-reactive species to the printing surface of the plate, may provide enhanced coverage of such species over the area of the printing surface of the plate, may provide enhanced durability of the plasma treatment, and so on. Methods of establishing such an ion sheath and of positioning a substrate within such an ion sheath, are described in detail in U.S. Pat. Nos. 7,125,603 and 7,387,081 (to David), both of which are incorporated by reference in their entirety herein for this purpose.

The plasma treatment environment may contain any desired gas or gas mixture (in this context, the term gas is used to broadly encompass any material that can be volatilized to a sufficient extent to be provided in a reaction chamber of a plasma reactor). If desired, it may comprise an inert gas such as argon, helium, xenon, radon, or any mixture thereof. In some embodiments, the plasma treatment may be performed in an oxidizing environment. This may enhance the degree to which the plasma treatment increases the surface energy of printing surface 101, as discussed later herein. Such an oxidizing environment may comprise at least one oxygen-containing gas (for example, an oxygen-containing gas selected from oxygen, water, hydrogen peroxide, ozone, and combinations thereof).

In some embodiments, the plasma treatment environment may include one or more organosilane constituents. Such constituents may e.g. enhance the degree to which certain high-surface-energy-imparting (e.g., oxygen-containing) moities may be attached, e.g. covalently bonded, to printing surface 101 of plate 100. In various embodiments, suitable organosilanes include, but are not limited to, tetramethylsilane (TMS), methylsilane, dimethylsilane, trimethylsilane, ethylsilane, tetraethylorthosilicate (TEOS), tetramethylcyclotetrasiloxane (TMCTS), disilanomethane, bis(methylsilano)methane, 1,2-disilanoethane, 1,2-bis(methylsilano)ethane, 2,2-disilanopropane, diethylsilane, diethylmethylsilane, propylsilane, vinylmethylsilane, divinyldimethylsilane, 1,1,2,2-tetramethyldisilane, hexamethyldisilane, hexamethydisiloxane (HMDSO), 1,1,2,2,3,3-hexamethyltrisilane, 1,1,2,3,3-pentamethyltrisilane, dimethyldisilanoethane, dimethyldisilanopropane, tetramethyldisilanoethane, tetramethyldisilanopropane, and the like, or combinations of two or more of the foregoing. In particular embodiments, the plasma treatment environment may comprise a mixture of an oxygen-containing constituent and an organosilane constituent, at any suitable ratio. In specific embodiments, a mixture of oxygen and tetramethyl silane may be used. In further embodiments a volumetric ratio of TMS to O₂ of about 1:3, 1:5, 1:8 or 1:10 may be used.

In various embodiments, such a plasma treatment (particularly if performed in an oxidizing environment) may increase the surface energy of printing surface 101 (which may often be in the range of e.g. 18-37 dyne/cm for conventional flexographic plates as supplied) to at least about 40, 60, or 70 dynes/cm. That is, in various embodiments the plasma treatment may increase the surface energy of printing surface 101 by an increment of at least about 5, 10, 20, 30, or 40 dynes/cm. It is noted that the plasma treatment may increase the surface energy of valley floors 106 as well as those of printing surface 101 (unless some measure is taken to mask valley floors 106). This may be of little or no consequence as long as the printing plate is designed (e.g. by way of a sufficient height differential between surfaces 101 and 106) that little or no liquid is transferred from the anilox roll to surface 106 and/or from surface 106 to the printable substrate. Of course, if desired, in particular embodiments the plasma treatment could be performed on the entire surface of the precursor material and then portions of the precursor material removed (along with their plasma-treated surfaces) to leave behind protrusions 102 with plasma-treated surfaces 101 thereon. In such embodiments valley floors 106 would not be plasma-treated surfaces.

Anilox roll 10 can be of any suitable design and comprised of any suitable material. It can comprise cells 12 of any suitable cell angle, cell volume, and cell density (e.g., line screen, as commonly reported in lines per inch). Often, a cell density of from 50-2000 line screen (cells per linear inch) may be used. The cell density may be chosen in view of the dimensions of the individual areas of printing surface 101 to which the liquid is to be transferred; e.g., so that each individual area of printing surface 101 (i.e., an area atop a protrusion 102) receives liquid from e.g. two, four, six or more such cells. In particular embodiments, the cell parameters (and the operating parameters of flexographic printing apparatus 1) may be chosen so that the liquid is transferred from the anilox roll onto each individual area of printing surface 101, as a layer that generally, substantially, or completely covers the entirety of that area of surface 101. In other words, in such embodiments the liquid is transferred so as to uniformly cover a given individual area of surface 101 rather than remaining as individual “pixels” (corresponding to each cell) that are spaced throughout that area of surface 101.

Printable substrate 50 can be any substrate to which it is desired to transfer a liquid and which has a major surface 51 that can acceptably receive such a liquid. Substrate 50 may be made of any suitable material (e.g. paper, plastic, metal), as desired. Substrate 50 may be a multi-layer substrate as long as surface 51 thereof is capable of receiving a desired liquid. If desired, major surface 51 of printable substrate 50 can be treated to improve the printability thereof with a particular liquid, through any well-known method. Specific (non-limiting) examples of some substrates which it may be desired to transfer a liquid to are discussed e.g. in U.S. Patent Application Publication No. No. 2010/0077932 to Pekurovsky. In some embodiments, printable substrate can be a moving substrate. In some embodiments, printable substrate 51 can be a continuous substrate (e.g. a segment of a continuous roll of paper, plastic film, etc.)

Any liquid (which term encompasses mixtures, slurries, suspensions, solutions, and so on) can be used that is capable of being acceptably transferred from cells 12 of anilox roll 10 to printing surface 101 of flexographic printing plate 100, and from there to surface 51 of printable substrate 50. In some embodiments, the liquid to be transferred may comprise no more than about 80, 60, 40, 30, 20, or 10% by weight of volatile materials (defined herein as encompassing water as well as any organic solvent with a boiling point of less than 150° C., in any combination, solution, or mixture thereof). In further embodiments, the liquid may comprise no more than about 4, 2, 1, 0.5, or 0.2% by weight of volatile materials. In some embodiments such a liquid may comprise one or more reactive materials, meaning monomers, oligomers, polymers, etc. that comprise chemically reactive groups by which means the liquid may be converted to a solid (that is, polymerized, crosslinked, or the like) after being transferred to surface 51 of substrate 50. In various embodiments, the liquid may comprise at least about 20, 40, 60, 80, 90, or 95% by weight of reactive materials. In particular embodiments, the liquid may be a “solventless” material, meaning that the liquid comprises less than about 0.2% of volatile materials (i.e., the liquid consists essentially of reactive materials and non-volatile materials (additives, etc.)). Such non-volatile additives might be particulate (e.g., filler such a mineral fillers, wood particles, conductive particles, and so on), or might be at least quasi-liquid although non-volatile (e.g., plasticizers, surfactants, smoothing agents and so on).

Whether a “solventless” composition or not, such a liquid may comprise any desired additive of any type (e.g. stabilizers, antioxidants, bactericides, wetting agents, UV-stabilizers, etc.). In some embodiments, the liquid may comprise one or more inks, colored pigments, or any combination thereof, so as to e.g. impart a desired color to the printed area of surface 51 of substrate 50. In other embodiments, the liquid may not comprise any inks or colored pigments. In such embodiments, a primary purpose of the liquid (once transferred to the substrate and solidified) may be something other than imparting a particular visual appearance (although the presence of the solidified liquid on the substrate may be incidentally apparent). That is, such a solidified liquid may serve the purpose of imparting (a desired area of) the substrate with e.g. a protective coating, an electrically-active coating (e.g., a conductive trace), an antibacterial coating, a friction-reducing surface, a texturizing surface, and so on. Even in the absence of inks or pigments, of course, the solidified liquid may still provide some kind of optical effect, for example serving as an antiglare coating on the printable substrate. Some particular (non-limiting) examples of materials (reactive materials, additives, etc.) which may be suitable constituents of a liquid to be transferred, can be found in U.S. Patent Application Publication No. No. 2010/0077932 to Pekurovsky.

In methods disclosed herein, a liquid is provided in cells 12 of anilox roll 10, and is transferred therefrom to printing surface 101 of flexographic printing plate 100. The liquid is then transferred from printing surface 101 to surface 51 of substrate 50. The liquid is of such composition, and/or the process parameters (e.g., the residence time of the liquid on printing surface 101) are controlled, so that the liquid is contacted with (and in some embodiments may be transferred to) surface 51 of substrate 50, while still at least substantially in liquid form. Such a process is by definition different from e.g. the processes disclosed in U.S. Patent Application Publication 2008/0233280 to Blanchet, in which a material is that is resident on a printing surface is contacted with a substrate only after the material is in substantially solid form (i.e., after enough volatile material has evaporated to ensure that the material is in the form of an at least semi-solid film, while still resident on the printing surface).

In various embodiments, no more than about 60, 40, 20, or 10% by weight of the liquid that was transferred (from the anilox roll) to the printing surface of the flexographic printing plate, evaporates during the time that the liquid is resident on the printing surface of the flexographic printing plate. In further embodiments, no more than about 4, 2, 1, or 0.5% by weight of the liquid that was transferred to the printing surface of the flexographic printing plate, evaporates during the time that the liquid is on the printing surface of the flexographic printing plate. It will be appreciated that any of these conditions may be met regardless of whether the liquid contains any volatile materials. In other words, even if the liquid contains some volatile materials the process may be controlled so that only a certain amount of the volatile materials evaporate while the liquid is resident on the printing surface of the printing plate. Any volatile materials may of course be evaporated from the liquid after it is transferred to the surface of the substrate, e.g. if the substrate is passed through a drying oven.

In any case, even if volatile material is present, not enough volatile material is removed from the liquid during its residence time on printing surface 101 to cause the liquid to be transformed into a film (i.e., a solid or semi-solid film that is then contacted with a printable substrate 50) as occurs in e.g. the processes disclosed in U.S. Patent Application Publication 2008/0233280. Thus, the transferring steps disclosed herein (e.g., transferring a liquid from an anilox roll to the printing surface of a plasma-treated flexographic printing plate and then transferring the liquid from the printing surface of the plasma-treated flexographic printing plate to a surface of a substrate) are by definition different from the processes disclosed in U.S. Patent Application Publication 2008/0233280. It is further noted that by “transferring” is specifically meant bringing a two substrates into close proximity with each other so that a layer of liquid (whether continuous or discontinuous) that is resident on a surface of the first substrate (e.g., that is in a cell of an anilox roll, or that is on the printing surface of a flexographic printing plate), is contacted with a surface of the second substrate (e.g. a printing surface of a flexographic printing plate, or a surface of a printable substrate) and is transferred from an area of the first substrate to a corresponding area of the second substrate. Such a transferring process is by definition distinguished from e.g. other coating processes such as e.g. knife coating, spin coating, spray coating, curtain coating, and so on.

In the present investigations, it has been discovered that the plasma treating of at least a printing surface 101 of a flexographic printing plate 100 can advantageously reduce the occurrence of pinholes on printed substrate 50. By pinholes is meant an area of surface 51 of substrate 50 that does not comprise (solidified) liquid thereon, even though the printing pattern of flexographic printing plate 100 was designed and intended to transfer liquid to that area. The present investigations have revealed that at least some such pinholes (which may range e.g. from a few microns in size (e.g. diameter or longest dimension) up to about 50-200 microns in size) may not necessarily result from any failure of the liquid to wet the substrate, or from any dewetting of the liquid from the substrate. Nor may they necessarily result from a failure to transfer the liquid from an area in which the liquid is present on printing surface 101, to the substrate; or, from any failure of the liquid to initially wet printing surface 101 when initially transferred thereto from the anilox roll.

Rather, in at least some cases, such pinholes seem to result from dewetting of the liquid from certain areas of printing surface 101 of printing plate 100. In other words, the source of the problem appears to be one of dewetting from printing surface 101, rather than from a failure to initially wet printing surface 101, and rather than from any failure to transfer the liquid to the substrate or from any failure of the liquid to wet the substrate or to stay wetted thereon.

With this appreciation, it has been discovered that plasma treatment of at least the printing surface 101 of the printing plate 100 to reduce such dewetting, can significantly reduce or even largely eliminate the occurrence of such pinholes on printed substrate 50. The ordinary artisan will appreciate that this is a surprising result. By way of comparison, an ordinary artisan might consider it to be unsurprising that any wetting failure (whether a failure to initially wet, or a dewetting phenomenon) that occurs on a printing surface in so-called solid-transfer printing would be problematic. This is because, such a material having been deposited on a printing surface as a liquid, developing a pinhole, and then losing enough volatile material to transform from a liquid to a solid (or at least a semi-solid), the material would have little or no ability to flow or spread (either while still on the printing surface, or during and after being transferred to the substrate). So, a pinhole, once present in such an at least semi-solid layer, could not be easily eliminated either while the layer is resident on the printing surface or on the printed substrate.

In sharp contrast, in the present case, it would be expected that even if a pinhole did develop in the liquid while it was resident on the printing surface of the flexographic printing plate, the contact pressure of the printing surface with the surface of the substrate would tend to make the liquid flow so as to essentially fill the pinhole (particularly for pinholes as small as e.g. a few microns in size). The present investigations have however revealed that in flexographic printing of liquids, pinholes can result from dewetting of the liquid on the printing surface, which pinholes are surprisingly not reduced or eliminated during transfer of the liquid to the substrate. With this realization, it has been found that plasma treatment of the printing surface can at least reduce the occurrence of such pinholes, and in some cases may significantly reduce or even largely eliminate them. Furthermore, it has been found that the effects of such plasma treatment appears to last through numerous (e.g., one hundred or more) printing cycles. Beyond this, such plasma treatment may impart the flexographic printing plate material with increased resistance to being penetrated and/or softened by e.g. organic liquids. This may enhance the ability of the printing plate to be used with a wide variety of liquids that may be desired to be transferred to a printable substrate, and/or may increase the longevity of the printing plate when used with such liquids.

It will be appreciated that the disclosures herein embrace many variations and embodiments. For example, if the liquid does comprise any reactive material, the above-disclosed process may include a step of promoting the reactive materials to react, e.g. by exposure to heat, radiation, etc. Although the discussions herein have primarily concerned an illustrative embodiment involving a roll-based flexographic printing apparatus and process (e.g., by use of an anilox roll in combination with a flexographic printing plate that is wrapped around a printing cylinder), it will be appreciated that in some embodiments flexographic printing might be done flat. That is, a plasma-treated printing plate might be held generally or strictly flat during the process of having a liquid transferred thereto and/or during the process of transferring a liquid therefrom to a substrate. It will be appreciated in such circumstances some other mechanism than an anilox roll might be used to transfer liquid to the printing plate.

### LIST OF EXEMPLARY EMBODIMENTS

Embodiment 1 is a method of flexographic printing, the method comprising: transferring a liquid from an anilox roll to a printing surface of a plasma-treated flexographic printing plate, and transferring the liquid from the printing surface of the plasma-treated flexographic printing plate to a surface of a substrate. Embodiment 2 is the method of embodiment 1 wherein no more than about 10% by weight of the liquid that was transferred to the printing surface of the plasma-treated flexographic printing plate, evaporates during the time that the liquid is resident on the printing surface of the plasma-treated flexographic printing plate. Embodiment 3 is the method of embodiment 1 wherein no more than about 1% by weight of the liquid that was transferred to the printing surface of the plasma-treated flexographic printing plate, evaporates during the time that the liquid is resident on the printing surface of the plasma-treated flexographic printing plate.

Embodiment 4 is the method any of embodiments 1-3 wherein the substrate is a moving substrate. Embodiment 5 is the method of any of embodiments 1-4 wherein the substrate is a continuous substrate. Embodiment 6 is the method of any of embodiments 1-5 wherein the liquid comprises no more than about 60% of volatile materials. Embodiment 7 is the method of any of embodiments 1-5 wherein the liquid comprises no more than about 20% of volatile materials. Embodiment 8 is the method of any of embodiments 1-5 wherein the liquid comprises no more than about 4% of volatile materials. Embodiment 9 is the method of any of embodiments 1-5 wherein the liquid comprises no more than about 1% of volatile materials.

Embodiment 10 is The method of any of embodiments 1-9 wherein the printing surface of the plasma-treated flexographic printing plate with liquid resident thereon, is not exposed to a drying step prior to the transferring of the liquid to the surface of the substrate. Embodiment 11 is the method of any of embodiments 1-10 wherein the liquid comprises one or more polymerizable (meth)acrylic constituents. Embodiment 12 is the method of any of embodiments 1-11 wherein the liquid does not comprise any inks or colored pigments. Embodiment 13 is the method of any of embodiments 1-12 wherein the printing surface of the plasma-treated flexographic printing plate is an exposed surface of a protruding portion of a cured photocurable material, which protruding portion was produced by the removal of adjacent areas of uncured photocurable material by solvent-washing. Embodiment 14 is the method of any of embodiments 1-12 wherein the printing surface of the plasma-treated flexographic printing plate is an exposed surface of a protruding portion of a polymeric material, which protruding portion was produced by the removal of adjacent areas of the polymeric material by laser engraving. Embodiment 15 is the method of any of embodiments 1-14 wherein the steps of the method are repeated at least one hundred times without performing an additional plasma-treatment of the printing surface of the flexographic printing plate.

Embodiment 16 is a method of plasma treating a flexographic printing plate, the method comprising exposing at least the printing surface of a flexographic printing plate to a plasma. Embodiment 17 is the method of embodiment 16 wherein the plasma comprises an oxidizing atmosphere. Embodiment 18 is the method of embodiment 17 wherein the oxidizing atmosphere contains O₂. Embodiment 19 is the method of any of embodiments 16-18 wherein the plasma comprises an organosilane. Embodiment 20 is the method of any of embodiments 16-19 wherein the plasma treatment is carried out by positioning at least the printing surface of the flexographic printing plate within an ion sheath that is located within a reaction chamber of a plasma reactor. Embodiment 21 is the method of any of embodiments 16-20 wherein the plasma treatment causes the surface energy of at least the printing surface of the flexographic printing plate to increase by at least about 10 dynes/cm. Embodiment 22 is the method of any of embodiments 16-20 wherein the plasma treatment causes the surface energy of at least the printing surface of the flexographic printing plate to increase by at least about 30 dynes/cm.

Embodiment 23 is an article comprising a flexographic printing plate comprising a plasma-treated printing surface. Embodiment 24 is the article of embodiment 23, prepared by the method of any of embodiments 16-22. Embodiment 25 is the method of flexographic printing of any of embodiments 1-15, using a flexographic printing plate prepared by the method of any of embodiments 16-22.

### EXAMPLES

Three flexographic printing plates were obtained of the type available from DuPont (Wilmington, Del.) under the trade designation Cyrel DPR. All three plates were processed (by Southern Graphic Systems (SGS, Minneapolis, Minn.)) to comprise the same predetermined print pattern based on a pdf image supplied to Southern Graphic Systems. The pattern comprised a grid comprised of sections (each of which section was a square area of approximately 5.1×5.1 cm), each of which sections contained square protrusions of a chosen size (approximately 40, 60, 80, 100, 200, and 400 microns on each side). In each section, the protruding squares were separated by intervening gaps (valleys) of a chosen width. In the different sections, gap widths of approximately 20, 30, 40 and 50 microns were used. (In other words, each section of the grid comprised square protrusions of a particular size (e.g., 100 microns on each side), separated by a particular gap width (e.g., 40 microns)). For all sections, the height differential between the printing surface of the protruding squares and the floor of the intervening valleys, was set (by the processing conditions) to be approximately 550 microns. Each printing plate comprised an overall size of approximately 16.5×23 cm.

All three printing plates were manually wiped with isopropanol upon receipt from SGS, and one was set aside as a Comparative Example. The other two printing plates (Working Examples 1 and 2) were plasma treated using apparatus and procedures of generally similar type to those described in Example 1 of U.S. Pat. No. 7,125,603. Both Working Examples were subjected to a preliminary plasma treatment of O₂ alone (without any tetramethylsilane (TMS) being present), at an approximate flow rate in the range of 500-1000 std. cm³/min and power of 500 watts for 120 seconds. Working Example 1 was then subjected to a plasma treatment with a mixture of TMS and O₂ at approximate flow rates of 150 std. cm³/min and 450 std. cm³/min, respectively corresponding to a TMS/O₂ volumetric ratio of approximately 1:3. Working Example 2 was subjected to a plasma treatment with a mixture of TMS and O₂ at a flow rates of approximately 50 std. cm³/min and 500 std. cm³/min, respectively corresponding to a TMS/O₂ volumetric ratio of approximately 1:10.

Contact angles on flat (etched) portions of each printing plate were estimated using de-ionized water and a PG-X Pocket Goniometer (available from Testing Machines Inc, New Castle, Del.). Results are shown in Table 1. The surface energy (in dyne/cm) was also estimated by way of dyne pens (of the general type available from various vendors).

TABLE 1

| | Plasma | Contact | | |
|---|---|---|---|---|
| Sample | Treatment | angle | Surface energy | |
| Comparative Example | None | ~92° | ~34** | dyne/cm |
| Working Example 1 | *1:3 TMS:O₂ | ~84° | ~38-46 | dyne/cm |
| Working Example 2 | *1:10 TMS:O₂ | ~64° | ~70*** | dyne/cm |

*After pretreatment with O2 plasma alone.
**Lower limit of dyne pen test range.
***Upper limit of dyne pen test range.

All three flexographic printing plates were mounted side-by-side on a smooth roll of a flexographic printing apparatus using 1060 Cushion-Mount flexographic plate mounting tape available from 3M. A flexographically printable liquid composition was prepared by combining 49.5 wt. % of a 1:1 mixture (by weight) of SR238 and SR295 (E10020, Sartomer USA, Exton, Pa.), 49.5 wt. % Ebecryl 8301-R (Cytec Industries, Woodland Park, N.J.), and 1.0 wt. % PL-100 (Palermo Lundahl Industries, Chisago City, Minn.) in an amber jar. The mixture was thoroughly admixed until all components were in solution to form an essentially “solventless” liquid material as described herein. The printable liquid composition was introduced into the flexographic printing apparatus using conventional methods and equipment and was transferred onto the printing surfaces of all three flexographic printing plates via a 900 cells per inch/3 BCM (billion cubic microns per square inch) ceramic anilox roll (available from Interflex, Spartanburg, S.C.). The printable composition was then transferred from the anilox roll to a printable substrate (a polymeric film available from 3M, St. Paul Minn., under the trade designation ENVISION 8458G), moving at a line speed of approximately 3 meters per minute. The substrate then passed through a UV curing apparatus (available from XericWeb, Neenah, Wis.) that was in-line with the printing apparatus. The substrate was passed through the curing apparatus (also at 3 meters per minute) so that the liquid material was satisfactorily cured to form a solid film.

Images of printed portions of the printed substrates were obtained using an optical microscope. Printed patterns produced with the printing plate that received no plasma treatment (Comparative Example) showed excessive (and unacceptable) pinholing, particularly at the larger feature sizes (e.g., with the 400 micron printed squares), as well as poor edge fidelity of the printed features. Plasma treatment at the 1:3 TMS:O₂ level showed improved performance over the Comparative Example, while plasma treatment at a 1:10 TMS:O₂ treatment level showed a dramatic improvement in performance over the Comparative Example.

Other experiments were also performed (e.g., some in the absence of a preliminary O₂ plasma treatment, and some on other printable substrates (such as polyester film)); the findings of such experiments generally followed the above-described pattern.

The foregoing Examples have been provided for clarity of understanding only. No unnecessary limitations are to be understood therefrom. The tests and test results described in the Examples are intended solely to be illustrative, rather than predictive, and variations in the testing procedure can be expected to yield different results. All quantitative values in the Examples are understood to be approximate in view of the commonly known tolerances involved in the procedures used.

It will be apparent to those skilled in the art that the specific exemplary structures, features, details, configurations, etc., that are disclosed herein can be modified and/or combined in numerous embodiments. (In particular, any of the elements that are positively recited in this specification as alternatives, may be explicitly included in the claims or excluded from the claims, in any combination as desired.) All such variations and combinations are contemplated by the inventor as being within the bounds of the conceived invention not merely those representative designs that were chosen to serve as exemplary illustrations. Thus, the scope of the present invention should not be limited to the specific illustrative structures described herein, but rather extends at least to the structures described by the language of the claims, and the equivalents of those structures. To the extent that there is a conflict or discrepancy between this specification as written and the disclosure in any document incorporated by reference herein, this specification as written will control.

What is claimed is:

1. A method of flexographic printing, the method comprising:
transferring a liquid from an anilox roll to a printing surface of a plasma-treated flexographic printing plate,
and
transferring the liquid from the printing surface of the plasma-treated flexographic printing plate to a surface of a substrate.

2. The method of claim 1 wherein no more than about 10% by weight of the liquid that was transferred to the printing surface of the plasma-treated flexographic printing plate, evaporates during the time that the liquid is resident on the printing surface of the plasma-treated flexographic printing plate.

3. The method of claim 1 wherein no more than about 1% by weight of the liquid that was transferred to the printing surface of the plasma-treated flexographic printing plate, evaporates during the time that the liquid is resident on the printing surface of the plasma-treated flexographic printing plate.

4. The method of claim 1 wherein the substrate is a moving substrate.

5. The method of claim 1 wherein the substrate is a continuous substrate.

6. The method of claim 1 wherein the liquid comprises no more than about 20% of volatile materials.

7. The method of claim 1 wherein the liquid comprises no more than about 1% of volatile materials.

8. The method of claim 1 wherein the printing surface of the plasma-treated flexographic printing plate with liquid resident thereon, is not exposed to a drying step prior to the transferring of the liquid to the surface of the substrate.

9. The method of claim 1 wherein the liquid comprises one or more polymerizable (meth)acrylic constituents.

10. The method of claim 1 wherein the liquid does not comprise any inks or colored pigments.

11. The method of claim 1 wherein the printing surface of the plasma-treated flexographic printing plate is an exposed surface of a protruding portion of a cured photocurable material, which protruding portion was produced by the removal of adjacent areas of uncured photocurable material by solvent-washing.

12. The method of claim 1 wherein the printing surface of the plasma-treated flexographic printing plate is an exposed surface of a protruding portion of a polymeric material, which protruding portion was produced by the removal of adjacent areas of the polymeric material by laser engraving.

13. The method of claim 1 wherein the steps of the method are repeated at least one hundred times without performing an additional plasma-treatment of the printing surface of the flexographic printing plate.

14. A method of plasma treating a flexographic printing plate, the method comprising:
exposing at least the printing surface of a flexographic printing plate to a plasma.

15. The method of claim 14 wherein the plasma comprises an oxidizing atmosphere.

16. The method of claim 15 wherein the oxidizing atmosphere contains O₂.

17. The method of claim 15 wherein the plasma comprises an organosilane.

18. The method of claim 14 wherein the plasma treatment is carried out by positioning at least the printing surface of the flexographic printing plate within an ion sheath that is located within a reaction chamber of a plasma reactor.

19. The method of claim 14 wherein the plasma treatment causes the surface energy of at least the printing surface of the flexographic printing plate to increase by at least about 10 dynes/cm.

20. The method of claim 14 wherein the plasma treatment causes the surface energy of at least the printing surface of the flexographic printing plate to increase by at least about 30 dynes/cm.

21. An article, comprising:
a flexographic printing plate comprising a plasma-treated printing surface.
